(19) United States
(12) Patent Application Publication
(10) Pub. No.: US 2014/0328158 A1
(43) Pub. Date: Nov. 6, 2014

(54) PROTECTION GROUP SWITCHING FOR CIRCUIT EMULATION

(71) Applicant: Mingchao Shao, Beijing (CN)

(72) Inventor: Mingchao Shao, Beijing (CN)

(73) Assignee: TELEFONAKTIEBOLAGET L M ERICSSON (PUBL), Stockholm (SE)

(21) Appl. No.: 14/343,370

(22) PCT Filed: Sep. 9, 2011
(86) PCT No.: PCT/CN2011/001532

§ 371 Date: Jul. 3, 2014

(51) Int. Cl. H04L 12/24; H04L 12/26; H04J 3/02

(52) U.S. Cl. CPC H04L 41/0663; H04J 3/02; H04L 43/10
USPC 370/218

(57) ABSTRACT

A secondary edge node is coupled between the packet network and a non-packet network and is adapted to function as follows when a failure associated with the primary edge node or circuitry coupled thereto occurs. First, the secondary edge node may detect a failure associated with the primary edge node, which is associated with a primary media access control (MAC) address that is used to direct the packet traffic from the first edge node to the primary edge node. Upon detecting the failure, the secondary edge node may send a switch request message including a secondary media access control address that is associated with the secondary edge node to the first edge node. Sending the switch request message indicates that the first edge node should start sending traffic for the first session to the secondary edge node using the secondary media access control address.

### TECHNICAL FIELD

The present disclosure relates to protection group switching for circuit emulation in a packet network.

### BACKGROUND

Time-division multiplexing (TDM) is a type of multiplexing that allows multiple bit streams to be delivered over a common communication channel at what appears to be the same time. In essence, the information for each of the respective streams is systematically broken into blocks. The blocks of information for the respective streams are then transferred over the common communication channel in different time slots. If there were three streams, the first block of information for the first stream may be transmitted over the common communication channel during a first time slot; the first block of information for the second stream may be transmitted over the common communication channel during a second time slot; and the first block of information for the third stream may be transmitted over the common communication channel during a third time slot. The process is repeated for each additional block of information for each of the streams.

TDM is employed in the legacy Public Switched Telephone Network (PSTN) and in most access networks for legacy first, second, and third generation (G, 2G, and 3G) mobile communication networks. In many instances, the TDM-based wireless access networks are coupled to the PSTN, which is used as the core transport network for mobile communications. While there is an extensive wireless access network infrastructure that employs TDM and continues to be heavily used, the core transport network services traditionally provided by the circuit-switched PSTN are being transitioned to more flexible and higher bandwidth packet networks by mobile service providers.

Further, packet network providers want to support mobile communications and are doing so by employing wireless access networks, which often employ TDM-based communications. Given the need for packet networks to support TDM-based communications in associated wireless access networks, technology has been developed to allow packet networks to effectively emulate a TDM network for those TDM-based wireless access networks that are connected to the packet network.

Exemplary packet networks that employ circuit emulation services include, but are not limited to Metropolitan Ethernet Networks (MEN), Multi-Protocol Label Switched (MPLS) networks, and Internet Protocol (IP) over MPLS networks. Circuit emulation services for MEN have been standardized in “Circuit Emulation Service Definitions, Framework and Requirements in Metro Ethernet Networks,” from The Metro Ethernet Forum (2004); and “Implementation Agreement for the Emulation of PDH Circuits over Metro Ethernet Networks,” from The Metro Ethernet Forum (2004). The International Telecommunication Unit (ITU) in Recommendation Y.1413, “TDM-MPLS Network Interworking-User Plane Interworking,” has standardized circuit emulation services for MPLS networks. The Internet Engineering Task Force (IETF) in RFC 4553, “Structure-Agnostic Time Division Multiplexing (TDM) over Packet (SAToP)” and RFC 5086, “Structure-Aware Time Division Multiplexed (TDM) Circuit Emulation Service over Packet Switched Network (CESoPSN),” has standardized circuit emulation services for IP over MPLS networks. These references are incorporated herein by reference in their entireties.

An exemplary communication network 10 in which circuit emulation services are provided is shown in FIG. 1A. As illustrated, a packet network (PN) 12 is associated with a number of provider edges (PE) 14A, 14B, and 14C. When discussed in general, the provider edges will be referenced as ‘14.’ When discussed in particular, the provider edges will be referenced particularly as 14A, 14B, or 14C, respectively. Other elements that have reference numerals supplemented with ‘A,’‘B,’ or ‘C’ are treated similarly.

On the subscriber side of the communication network 10, the provider edge 14A is depicted as being connected to a customer edge (CE) 16 via an Ethernet-based network (E-NET) or the like that employs packet-based communications. The customer edge 16 is part of a wireless access network 18, which employs one or more base transceiver stations (BTS) 20 that facilitate wireless communications with any number of user elements (UE) 22. The user elements 22 may take the form of mobile telephones, smart phones, personal digital assistants, modems, tablet computers, personal computers, and the like.

The wireless link between the user elements 22 and the base transceiver station 20 may employ any of the available multiple access techniques for mobile communications, such as code division multiple access (CDMA), time division multiple access (TDMA), orthogonal frequency division multiple access (OFDMA), and the like. The link between the base station transceiver 20 and the customer edge 16 may employ a wired or wireless link that employs TDM-based communications or is capable of carrying TDM circuits. For example, these links may be supported by T1, T2, E1, E3, or synchronous digital hierarchy (SDH) STM-N based connections.

On the core side of the communication network 10, provider edges 14B and 14C are each coupled to a base station controller (BSC) 24 via respective TDM-based attachment circuits 26. The attachment circuits 26 may also be supported by T1, T2, E1, or E3, or STM-N TDM based circuits. The base station controller 24 may be coupled to a core network.

An exemplary communication path, which is referred to as the primary communication path CP_{P}, extends from the lower one of the user elements 22 to the core network via the base transceiver station 20 and the customer edge 16 of the access network 18, provider edges 14A and 14B of the packet network 12, and the base station controller 24. The portions of the primary communication path CP_{P} between the base transceiver station 20 and the customer edge 16 as well as between the provider edge 14B and a destination in the core network are TDM based. However, the portion of the primary communication path CP_{P} between the customer edge 16 and the provider edge 14B is packet based.

Interworking functions 28 are employed to interface the TDM based portions and the packet based portions of the primary communication path CP_{P}. In the illustrated example, the customer edge 16 has an interworking function 28A, the provider edge 14B has an interworking function 28B, and the provider edge 14C has an interworking function 28C. If the TDM based communications were provided from the base transceiver station 20 to the provider edge 14A, the interworking function 28A would be provided in the provider edge 14A instead of in the customer edge 16.

The interworking function 28A of the customer edge 16 functions as follows. For communication traffic of a communication session arriving from the user element 22, the TDM based communication traffic for the communication session is received, buffered, broken into segments, and placed into packets. The destination for the packets is the media access control (MAC) address of the provider edge 14B. The packets are then transported via the provider edge 14A and packet network 12 to the provider edge 14B.

The provider edge 14B will receive the packets for the communication session and pass them to interworking function 28B. The segments of communication traffic are systematically extracted from the packets, placed into the proper order, and transmitted to the base station controller 24 in a TDM based format via the corresponding attachment circuit 26. The base station controller 24 will direct the TDM based communication traffic toward the intended destination over the core network.

For communication traffic of the communication session that is coming from the core network and directed to the user element 22, the above process is reversed. In particular, the base station controller 24 will receive TDM based communication traffic from the core network and direct the communication traffic toward the provider edge 14B. The provider edge 14B will pass the communication traffic to the interworking function 28B, which will receive, buffer, and break the TDM based communication traffic into segments. These segments are placed into corresponding packets. The destination for the packets is the MAC address of the customer edge 16. The packets are then transported via the provider edge 14B, packet network 12, and the provider edge 14A to the customer edge 16 via the primary communication path CP_{P}.

The customer edge 16 will receive the packets for the communication session and pass them to interworking function 28A. The segments of communication traffic are systematically extracted from the packets, placed into the proper order, and transmitted to the base transceiver station 20 in a TDM based format. The base transceiver station 20 will then transmit communication traffic to the appropriate user element 22. As described above, each interworking function 28A and 28B provides an adaptation function between the TDM and packet network interfaces of the customer edge 16 and the provider edge 14B. The interworking function 28C of provider edge 14C operates in the same manner.

When employing circuit emulation services in a communication network 10, operators typically provide a redundant, or backup, provider edge 14 in case there is a failure of the provider edge 14 or its associated attachment circuit 26. As illustrated, the redundant device is provider edge 14C, which is equipped with interworking function 28C. If there is a failure of the provider edge 14B or its associated attachment circuit 26, a secondary communication path CP_{S} can be established for the communication session via the provider edge 14C and its associated attachment circuit 26, as illustrated in FIG. 1B. Unfortunately, switching from the primary communication path CP_{P} (FIG. 1A) to the secondary communication path CP_{S} (FIG. 1B) requires manual provisioning of the customer edge 16.

As noted above, the provider edge 14B is associated with a MAC address. For circuit emulation services, the MAC address of the provider edge 14B is used by the interworking function 28A of the customer edge 16 as the destination address for packets that carry communication traffic for the communication session and are directed to the provider edge 14B. The MAC address of the provider edge 14B is often manually configured in the customer edge 16 when the customer edge 16 is provisioned. As such, to have the customer edge 16 direct the packets for the communication session to a backup provider edge 14 requires an operator to manually change the destination MAC address that is used to forward packets for the communication session. The need to manually reconfigure the destination MAC address is problematic when a failure occurs in the provider edge 14B or in its attachment circuit 26 of the primary communication path CP_{P}, because there is no way to avoid substantially interrupting communication sessions that are in progress with manual operations.

When a failure is detected, the operator must manually change the destination MAC address, which is used by the interworking function 28A to set the destination address for the packets that carry the communication traffic. Thus, when there is a failure of the provider edge 14B or its associated attachment circuit 26, the operator will manually access the customer edge 16 and change the destination MAC address that sets the destination in the packet network 12 for packets carrying communication traffic from that of the provider edge 14B to that of the provider edge 14C.

Once the destination MAC is changed as described, the TDM based communication traffic from the user element 22 is received, buffered, broken into segments, and placed into packets by the interworking function 28A. The destination for the packets is now the MAC address of the provider edge 14C instead of the MAC address of the provider edge 14B. The packets are then transported via the provider edge 14A and packet network 12 to the provider edge 14C.

The provider edge 14C will receive the packets for the communication session and pass them to interworking function 28C. The segments of communication traffic are systematically extracted from the packets, placed into the proper order, and transmitted to the base station controller 24 in a TDM based format via the corresponding attachment circuit 26. The base station controller 24 will direct the TDM based communication traffic toward the intended destination over the core network.

While having the primary edge 14C as a backup is extremely beneficial, the time required to manually transition communication traffic from the primary communication path CP_{P} to the secondary communication path CP_{S} is sufficiently long to significantly interrupt an existing communication session. As such, there is a need for a way to quickly transition from the primary communication path CP_{P} to the secondary communication path CP_{S} upon detecting a failure associated with a provider edge 14 or its associated attachment circuit 26 of a primary communication path CP_{P} with little or no interruption in an existing communication session.

### SUMMARY

The present disclosure relates to implementing a protection group of edge nodes in a packet network that is configured to provide non-packet emulation services. An exemplary emulation service is one that employs various edge nodes to emulate a TDM circuit over the packet network. Assume a first edge node receives non-packet traffic for a first session, converts the non-packet traffic to packet traffic, and sends the packet traffic to a primary edge node over the packet network. Further assume that the protection group includes the primary edge node and a secondary edge node. The primary edge node receives the packet traffic, reconverts the packet traffic to TDM traffic, and sends the TDM traffic towards its destination. As such, a communication path for the first session is established in part over the packet network and through the first edge node and the primary edge node.

The secondary edge node is coupled between the packet network and a non-packet network and is adapted to function as follows when a failure associated with the primary edge node or circuitry coupled thereto occurs. First, the secondary edge node may detect a failure associated with the primary edge node, which is associated with a primary media access control (MAC) address that is used to direct the packet traffic from the first edge node to the primary edge node. Upon detecting the failure, the secondary edge node may send a switch request message including a secondary media access control address that is associated with the secondary edge node to the first edge node. Sending the switch request message indicates that the first edge node should switch from sending the traffic for the first session toward the primary edge node using the primary media access control address to sending traffic for the first session to the secondary edge node using the secondary media access control address.

In one embodiment, the secondary edge node is adapted to monitor operational messages that are periodically sent by the primary edge node to indicate that the primary edge node is operational and detect the failure when the primary edge node stops sending the operational messages. In another embodiment, the secondary edge node is adapted to periodically send status request messages to the primary edge node, monitor operational messages that are sent in response to the status request messages by the primary edge node to indicate that the primary edge node is operational, and detect the failure when the primary edge node stops sending the operational messages.

In one embodiment, the non-packet network is a TDM network, and the primary edge node is coupled to the TDM network via a first attachment circuit and at least one of a base station controller and a radio network controller. Further, the secondary edge node is coupled to the TDM network via a second attachment circuit and at least one of a base station controller and a radio network controller. The first edge node may be coupled between the packet network and a wireless access network that supports wireless communications with a user element. The communications may involve, voice, data, or a combination thereof.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIGS. 1A and 1B respectively illustrate primary and secondary communication paths in a typical protection group switching environment according to the related art.

FIG. 2 illustrates a primary communication path that is established prior to a failure of one of the protection group edge nodes, according to one embodiment of the present disclosure.

FIG. 3A illustrates a partial failure of an edge node or a failure in an attachment circuit that supports the primary communication path in FIG. 2 and the signaling that initiates a failover process according to one embodiment of the present disclosure.

FIG. 3B illustrates establishment of a secondary communication path in response to the failover process of FIG. 3A being initiated according to one embodiment of the present disclosure.

FIG. 4A illustrates a failure of an edge node that supports the primary communication path in FIG. 2 and the signaling that initiates a failover process according to the present disclosure.

FIG. 4B illustrates establishment of a secondary communication path in response to the failover process of FIG. 4A being initiated according to the present disclosure.

FIG. 5 illustrates an exemplary packet for a switch request message according to one embodiment of the present disclosure.

FIG. 6 illustrates an exemplary edge node according to one embodiment of the present disclosure.

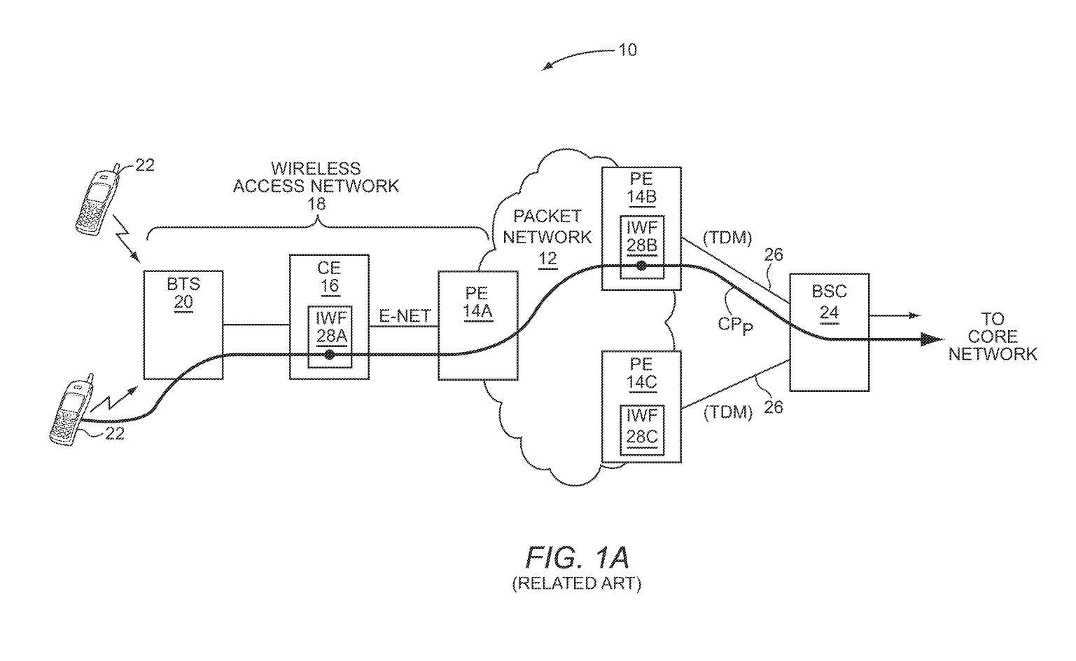

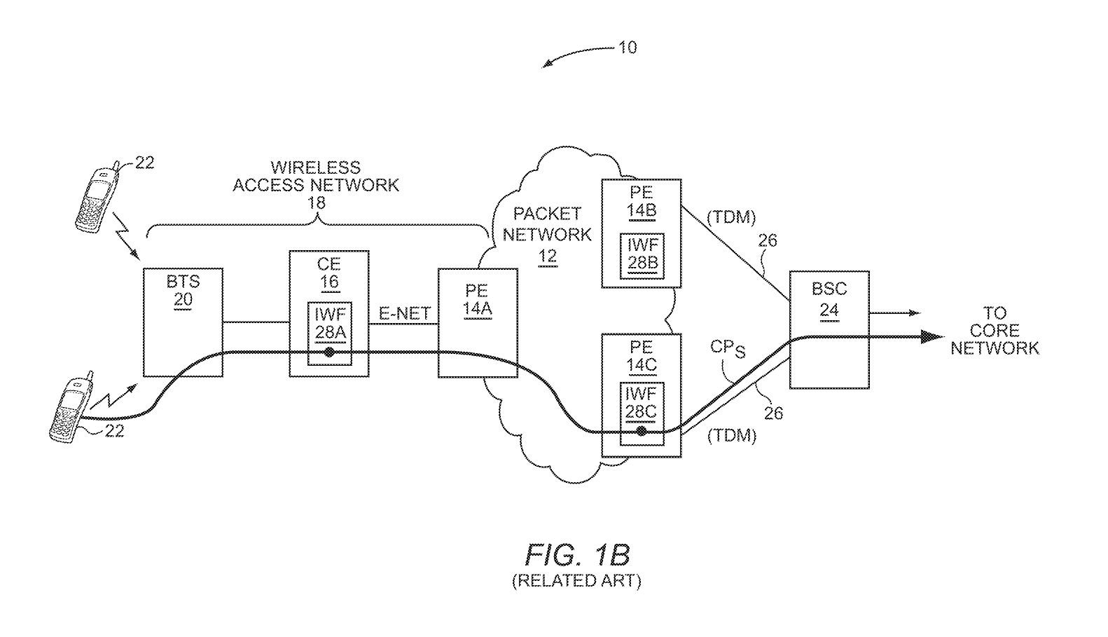

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

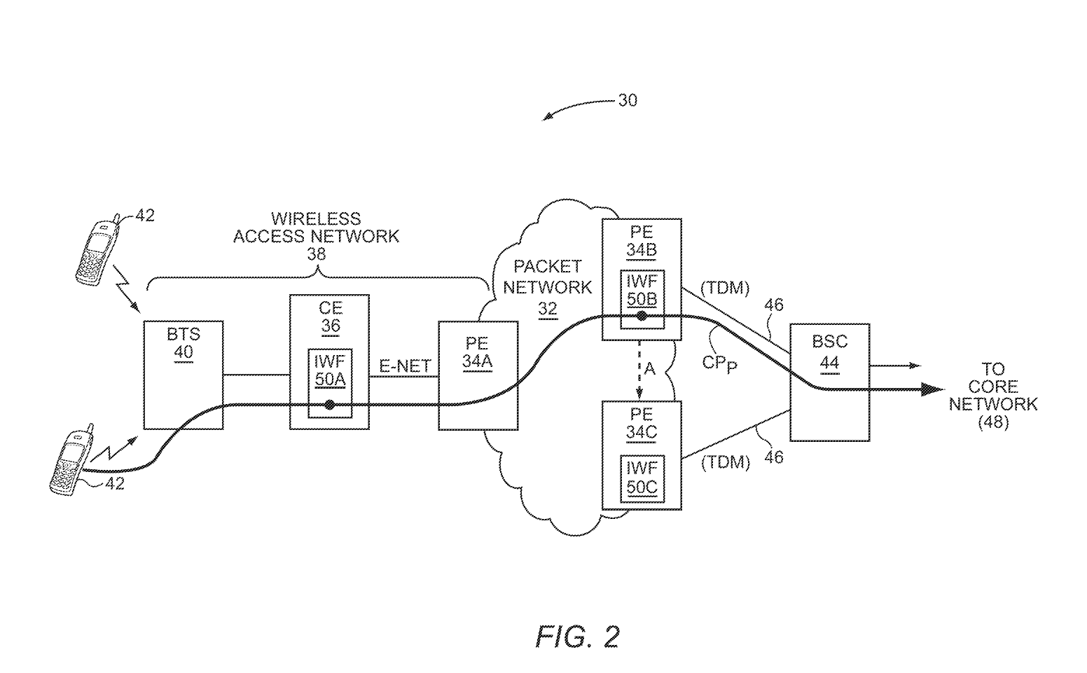

An exemplary communication network 30, in which circuit emulation services are provided according to the present disclosure, is shown in FIG. 2. A packet network (PN) 32 is associated with a number of provider edges (PE) 34A, 34B, and 34C. When discussed in general, the provider edges will be referenced as ‘34.’ When discussed in particular, the provider edges will be referenced particularly as 34A, 34B, or 34C, respectively. Other elements that have reference numerals supplemented with ‘A,’‘B,’ or ‘C’ are treated similarly.

On the subscriber side of the communication network 30, the provider edge 34A is depicted as being connected to a customer edge (CE) 36 via an Ethernet-based network (E-NET) or the like that employs packet-based communications. The customer edge 36 is part of a wireless access network 38, which employs one or more base transceiver stations (BTS) 40 that facilitate wireless communications with any number of user elements (UE) 42. The user elements 42 may take the form of mobile telephones, smart phones, personal digital assistants, modems, tablet computers, personal computers, and the like. A group of base transceiver stations 20 are generally distributed over a geographic area such that the group as a whole provides cellular coverage for the user elements 42.

The wireless link between the user elements 42 and the base transceiver station 40 may employ any of the available multiple access techniques for mobile communications, such as code division multiple access (CDMA), time division multiple access (TDMA), orthogonal frequency division multiple access (OFDMA), and the like. The link between the base transceiver station 40 and the customer edge 36 may employ a wired or wireless link that employs TDM-based communications or is capable of carrying TDM circuits. For example, these links may be supported by T1, T2, E1, E3, synchronous optical networking (SONET), SDH STM-N based connections.

The base transceiver station 40 is broadly defined and is intended to encompass traditional cellular base stations, wireless access points, Node B devices, and the like.

On the core, or hub, side of the communication network 30, provider edges 34B and 34C are each coupled to a base station controller (BSC) 44 via respective TDM-based attachment circuits 46. The attachment circuits 46 may also be supported by T1, T2, E1, E3, or STM-N TDM based circuits. The base station controller 44 may be coupled to a core network 48, such as the PSTN or the like. Further, the base station controller 44 is broadly defined and is intended to encompass traditional base station controllers, radio network controllers (RNCs), and the like.

An exemplary communication path, which is referred to as the primary communication path CP_{P}, extends from the lower one of the user elements 42 to the core network 48 via the base transceiver station 40 and the customer edge 36 of the wireless access network 38, provider edges 34A and 34B of the packet network 32, and the base station controller 44. The portions of the primary communication path CP_{P} between the base transceiver station 40 and the customer edge 36 as well as between the provider edge 34B and a destination in the core network 48 are TDM based. However, the portion of the primary communication path CP_{P} between the customer edge 36 and the provider edge 34B is packet based.

Interworking functions 50 are employed to interface the TDM based portions and the packet based portions of the primary communication path CP_{P}. As illustrated, the customer edge 36 has an interworking function 50A, the provider edge 34B has an interworking function 50B, and the provider edge 34C has an interworking function 50C. If the TDM based communications were provided from the base transceiver station 40 to the provider edge 34A, the interworking function 50A would be provided in the provider edge 34A instead of in the customer edge 36.

The interworking function 50A of the customer edge 36 functions as follows. For communication traffic of a communication session arriving from the user element 42, the TDM based communication traffic for the communication session is received, buffered, broken into segments, and placed into packets. The destination for the packets is the media access control (MAC) address of the provider edge 34B. The packets are then transported via the provider edge 34A and packet network 32 to the provider edge 34B.

The provider edge 34B will receive the packets for the communication session and pass them to interworking function 50B. The segments of communication traffic are systematically extracted from the packets, placed into the proper order, and transmitted to the base station controller 44 in a TDM based format via the corresponding attachment circuit 46. The base station controller 44 will direct the TDM based communication traffic toward the intended destination over the core network 48.

For communication traffic of the communication session that is coming from the core network 48 and directed to the user element 42, the above process is reversed. In particular, the base station controller 44 will receive TDM based communication traffic from the core network 48 and direct the communication traffic toward the provider edge 34B. The provider edge 34B will pass the communication traffic to the interworking function 50B, which will receive, buffer, and break the TDM based communication traffic into segments. These segments are placed into corresponding packets. The destination for the packets is the MAC address of the customer edge 36. The packets are then transported via the provider edge 34B, packet network 32, and the provider edge 34A to the customer edge 36 via the primary communication path CP_{P} .

The customer edge 36 will receive the packets for the communication session and pass them to interworking function 50A. The segments of communication traffic are systematically extracted from the packets, placed into the proper order, and transmitted to the base transceiver station 40 in a TDM based format. The base transceiver station 40 will then transmit communication traffic to the appropriate user element 42. As described above, each interworking function 50A and 50B provides an adaptation function between the TDM and packet network interfaces of the customer edge 36 and the provider edge 34B. As described below, the interworking function 50C of provider edge 34C is configured to operate in the same manner.

When employing circuit emulation services in a communication network 30, a redundant, or backup, provider edge 34C is provisioned in case there is a failure of the provider edge 34B or its associated attachment circuit 46. As illustrated, the provider edge 34C is equipped with interworking function 50C. If there is a failure of the provider edge 34B or its associated attachment circuit 46, a secondary communication path CP_{S} is quickly and automatically established for the communication session via the provider edge 34C and its associated attachment circuit 46.

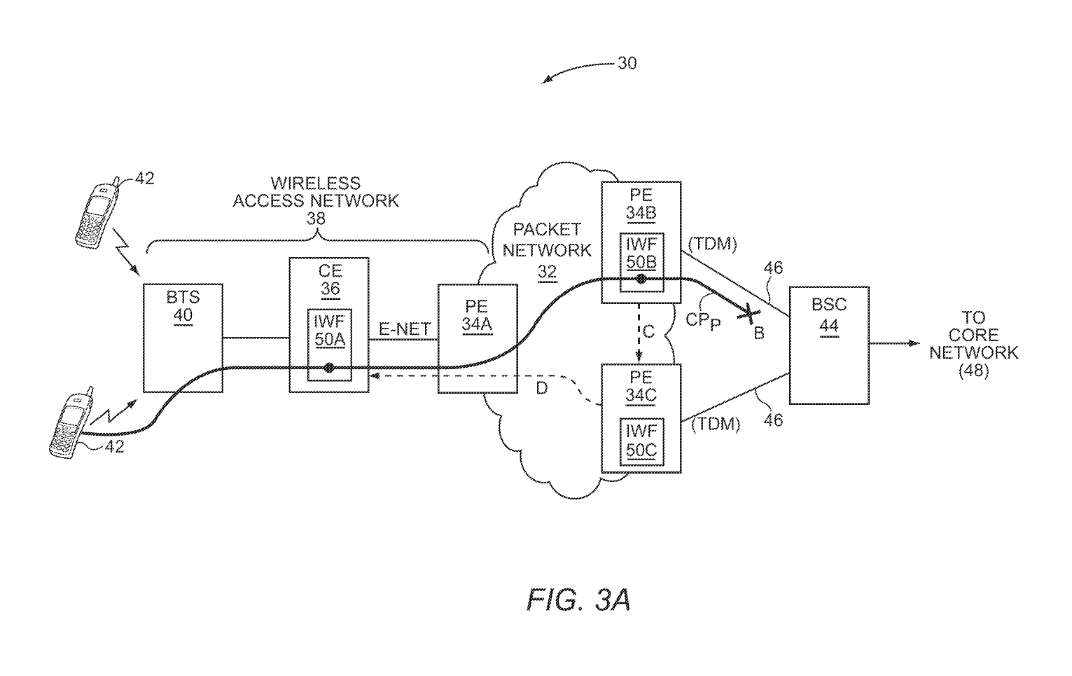

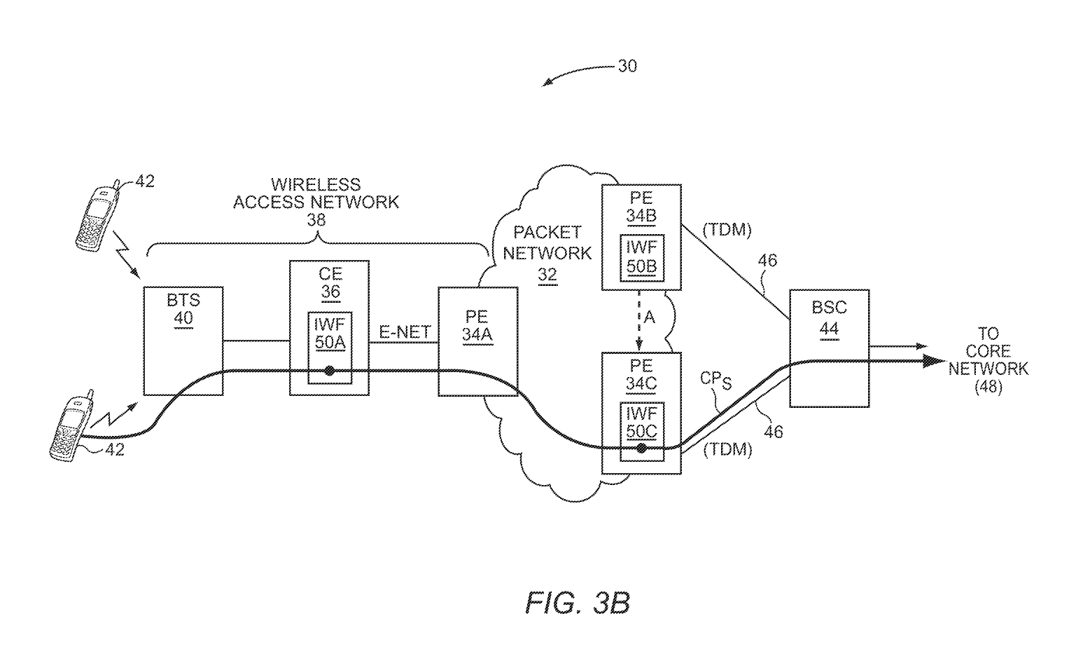

With reference to FIGS. 3A and 3B, a failover scenario is provided where a failure of the attachment circuit 46 that is connected to the provider edge 34B or a partial failure of the provider edge 34B occurs. Assume that the primary communication path CP_{P} is initially established as described in association with FIG. 2 between the user element 42 and another terminal (not shown) in the core network 48 and all elements are operating properly. Assume that the provider edge 34B is configured to send operational messages (Step A, in FIG. 2), which are indicative of the operation status of the provider edge 34B, the attachment circuit 46 that is associated with the provider edge 34B, or a combination thereof, to the provider edge 34C. For example, the operational messages may be systematically pushed to the provider edge 34C or sent in response to status request messages that are sent to the provider edge 34B from the provider edge 34C. When the provider edge 34B and the associated attachment circuit 46 are operating properly, the operational messages that are sent to the provider edge 34C from the provider edge 34B will indicate the same. The provider edge 34C may take no action in response to receiving the operational messages from the provider edge 34B.

With particular reference to FIG. 3A, assume a failure of the attachment circuit 46 that is connected to the provider edge 34B or a partial failure of the provider edge 34B occurs. When the attachment circuit 46 fails or there is a partial failure of the provider edge 34B (Step B, FIG. 3A), the provider edge 34B will detect the failure and send an operational message to the provider edge 34C (Step C, FIG. 3A). The operational message indicates that session traffic for the communication session can no longer flow along the primary communication path CP_{P} due to a failure of the attachment circuit 46 that is connected to the provider edge 34B or a partial failure of the provider edge 34B.

Upon receipt of the operational message from the provider edge 34B, the provider edge 34C will analyze the operational message and determine that a failure of the attachment circuit 46 that is connected to the provider edge 34B or a partial failure of the provider edge 34B has occurred. In response to detecting the failure, the provider edge 34C will send a switch request message to the customer edge 36 (Step D, FIG. 3A). The switch request message indicates that the customer edge 36 should switch from sending communication traffic for the communication session toward the provider edge 34B to sending the communication traffic for the communication session to the provider edge 34C.

Notably, the switch request message will include the MAC address for provider edge 34C. The switch request message is generally embodied in a packet that is passed through the packet network 32 and provider edge 34A to the customer edge 36. The MAC address for the provider edge 34C may be provided in the destination address field of the switch request message. Alternatively, the MAC address for the provider edge 34C may be provided in any applicable field, header, or payload of the packet, as long as the customer edge 36 knows or is instructed to use the MAC address for sending the packets that carry the communication traffic for the communication session to the provider edge 34C.

The customer edge 36 will receive the switch request message and quickly switch to sending the packets that carry the communication traffic for the communication session toward the provider edge 34C using the MAC address for the provider edge 34C, as illustrated in FIG. 3B. As such, the TDM based communication traffic from the user element 42 continues to be received, buffered, broken into segments, and placed into packets by the interworking function 50A of the customer edge 36. However, the destination for the packets is now the MAC address of the provider edge 34C instead of the MAC address of the provider edge 34B. As such, the packets are transported to the provider edge 34C via the provider edge 34A and packet network 32.

The provider edge 34C will receive the packets for the communication session and pass them to interworking function 50C. The segments of communication traffic are systematically extracted from the packets, placed into the proper order, and transmitted to the base station controller 44 in a TDM based format via the corresponding attachment circuit 46. The base station controller 44 will direct the TDM based communication traffic toward the intended destination over the core network 48.

Preferably, the interruption in the flow of communication traffic for the communication session caused by the failure and the subsequent transition from using provider edge 34B to using provider edge 34C is about 50 milliseconds or less. In one embodiment, the actual failover functionality described above, including the failure detection and associated messaging, for the respective customer edge 36, provider edge 34B, and provider edge 34C is provided by the interworking functions 50A, 50B, and 50C. Further, the communications between the provider edges 34B and 34C may be facilitated using an Inter-Chassis Communication Protocol (ICCP), such as that described in IETF Internet Draft “Inter-Chassis Communication Protocol for L2VPN PE Redundancy,” by Martini et al., which is incorporated herein by reference in its entirety. Other protocols may be used to support communications between the various nodes.

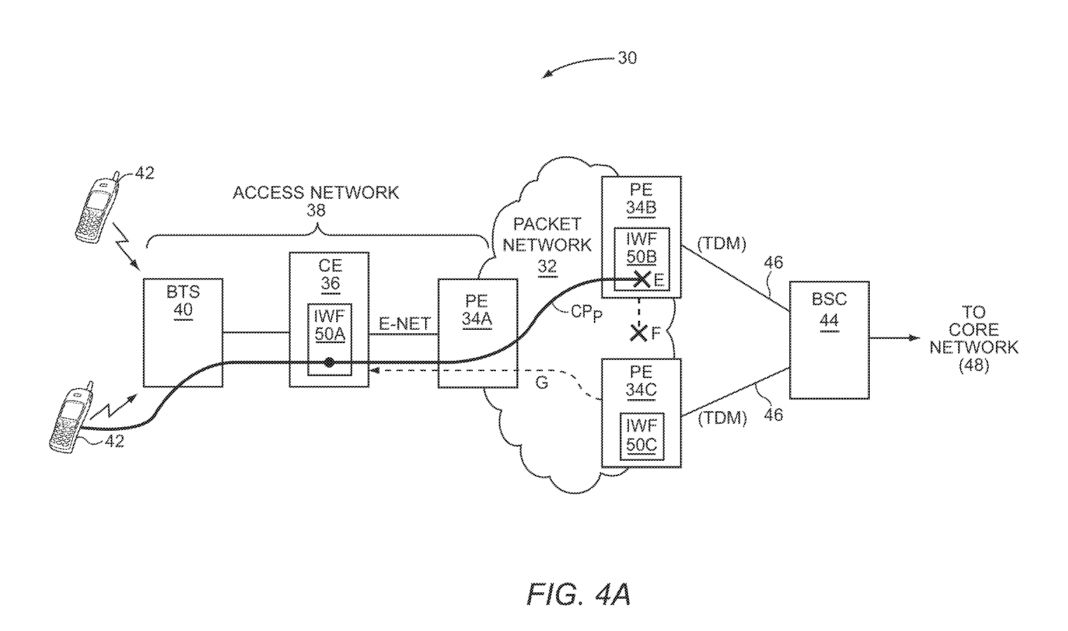

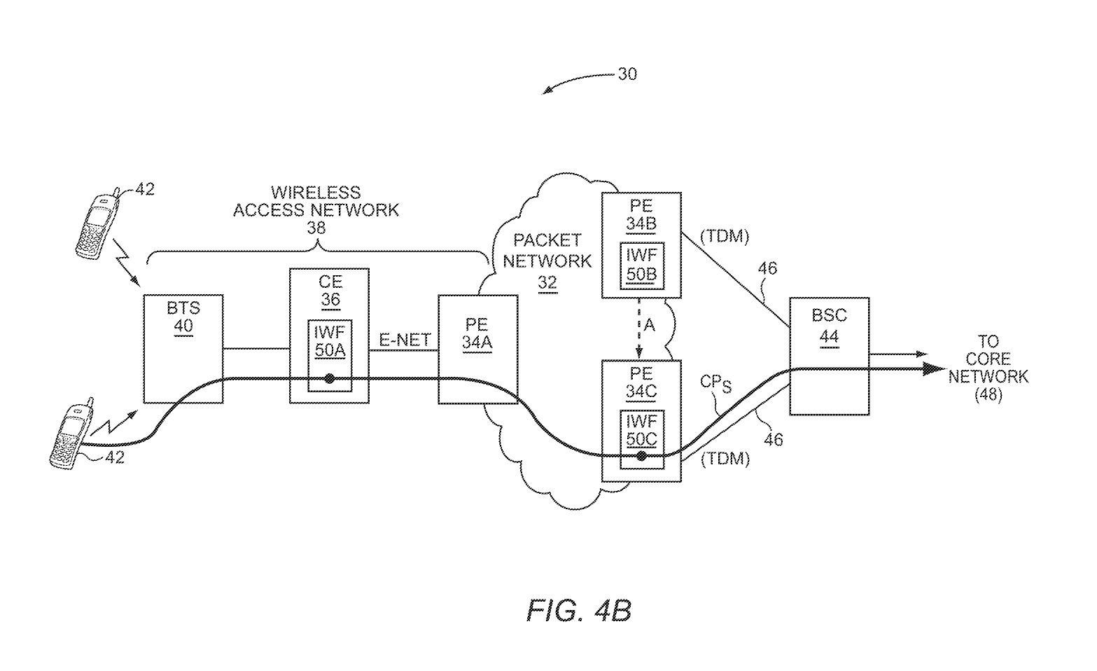

With reference to FIGS. 4A and 4B, a failover scenario is provided where a failure of the provider edge 34B occurs. Assume that the primary communication path CP_{P} is initially established as described in association with FIG. 2 between the user element 42 and another terminal (not shown) in the core network 48 and all elements are operating properly. Assume that the provider edge 34B is normally configured to send operational messages (Step A in FIG. 2), which are indicative of the operation status of the provider edge 34B, the attachment circuit 46 that is associated with the provider edge 34B, or a combination thereof, to the provider edge 34C.

With particular reference to FIG. 4A, assume that a failure of the provider edge 34B occurs (Step E, FIG. 4A) and that the failure prevents the provider edge 34B from sending the operational messages to the provider edge 34C. When the provider edge 34B stops sending the operational messages, the provider edge 34C will detect that the operational messages are no longer being sent by the provider edge 34B (Step F, FIG. 4A). As noted, above, the provider edge 34B may normally send the operational messages on a systematic basis or may send the operational messages in response to status requests sent by the provider edge 34C. In either case, the provider edge 34C is expecting the receipt of the operational messages, and when an expected operational message is not received within a set period of time, provider edge 34C can determine that a failure of some fashion has occurred at the provider edge 34B.

In response to detecting a failure of provider edge 34B, the provider edge 34C will send a switch request message to the customer edge 36 (Step G, FIG. 4A). The switch request message indicates that the customer edge 36 should switch from sending communication traffic for the communication session toward the provider edge 34B to sending the communication traffic for the communication session to the provider edge 34C.

Notably, the switch request message will include the MAC address for provider edge 34C. The switch request message is generally embodied in a packet that is passed through the packet network 32 and provider edge 34A to the customer edge 36. The MAC address for the provider edge 34C may be provided in the destination address field of the switch request message. Alternatively, the MAC address for the provider edge 34C may be provided in any applicable field, header, or payload of the packet, as long as the customer edge 36 knows or is instructed to use the MAC address for sending the packets that carry the communication traffic for the communication session to the provider edge 34C.

The customer edge 36 will receive the switch request message and quickly switch to sending the packets that carry the communication traffic for the communication session toward the provider edge 34C using the MAC address for the provider edge 34C, as illustrated in FIG. 4B. As such, the TDM based communication traffic from the user element 42 continues to be received, buffered, broken into segments, and placed into packets by the interworking function 50A of the customer edge 36. However, the destination for the packets is now the MAC address of the provider edge 34C instead of the MAC address of the provider edge 34B. As such, the packets are transported to the provider edge 34C via the provider edge 34A and packet network 32.

The provider edge 34C will receive the packets for the communication session and pass them to interworking function 50C. The segments of communication traffic are systematically extracted from the packets, placed into the proper order, and transmitted to the base station controller 44 in a TDM based format via the corresponding attachment circuit 46. The base station controller 44 will direct the TDM based communication traffic toward the intended destination over the core network 48.

Again, the interruption in the flow of communication traffic for the communication session caused by the failure and the subsequent transition from using provider edge 34B to using provider edge 34C is preferably about 50 milliseconds or less. In one embodiment, the actual failover functionality described above, including the failure detection and associated messaging, for the respective customer edge 36, provider edge 34B, and provider edge 34C is provided by the interworking functions 50A, 50B, and 50C.

When a failure occurs in the provider edge 34B, the communication traffic for the communication session is switched to the secondary communication path CP_{S}, which passes through the provider edge 34C. As described above, the communication traffic coming from the user element 42 is redirected from the primary communication path CP_{P} to the secondary communication path CP_{S}. Notably, the communication traffic for the communication session coming from the core network 48 and intended for the user element 42 should also be redirected from the primary communication path CP_{P} to the secondary communication path CP_{S}.

In one embodiment, the base station controller 44 can detect the receipt of communication traffic for the communication session coming from the provider edge 34C, as opposed to the provider edge 34B, and immediately begin sending the communication traffic that is directed to the user element 42 toward the provider edge 34C via its associated attachment circuit 46. Alternatively, one of the provider edges 34B or 34C may send a failover message to the base station controller 44 or an associated management entity to instruct the base station controller 44 to switch from the primary communication path CP_{P} to the secondary communication path CP_{S}. There is a benefit to having the provider edge 34C send failover messages in case the provider edge 34B has had a failure that prevents it from sending a failover message toward the base station controller 44.

While the redundancy described above is provided in the provider edges 34B and 34C on the core, or hub, side of the packet network 32, the same type of redundancy may be provided on the access side of the packet network 32 by providing redundant customer edges 36 or like node that provides the interworking function 50A. As such, the redundant customer edges 36 would provide a protection group that is essentially a mirror image of the provider edges 34B and 34C.

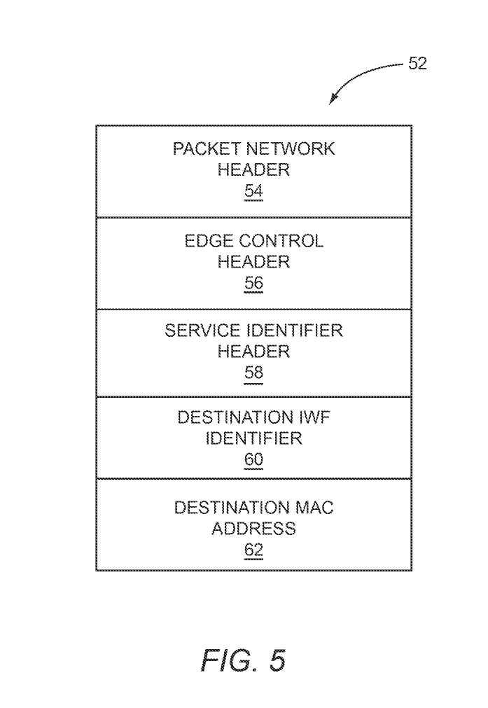

With reference to FIG. 5, an exemplary packet 52 for providing a switch request message is illustrated. The packet 52 may include a packet network header 54, an edge control header 56, a service identifier header 58, a destination IWF identifier 60, and a destination MAC address 62. The packet network header 54 may have different fields depending on the type of packet network 32. In a MEN, the packet network header 54 may include one more service or customer virtual local area network (VLAN) tags. In an MPLS based network, the packet network header 54 may include Label Switched Path (LSP) or Pseudowire (PW) labels. The packet network header 54 is effectively the encapsulation header for the given packet network 32.

The packet network header 54 may also include link headers depending on the type of physical link that will be used or is currently being used for transport. For Ethernet transport, the packet network header 54 may include source and destination MAC addresses along with the Ethernet field type. For a switch request message, the source MAC address may be the address of the backup edge node, such as the provider edge 34C that was described in the above examples.

The edge control header 56 can be used to carry miscellaneous information, such as version information, various flags, sequence numbers, reason codes, and the like. The information carried therein may identify the type of failure, provide specific instructions for handing the failure, and the like. The service identifier header 58 may be used to identify the new edge node that to which the communication traffic should be redirected. In the above examples, the communication service between the BTS 40 and the BSC 44 would be identified in the service identifier header 58. The destination IWF identifier 60 may be used to identify the new interworking function 50 in the edge node to which the communication traffic should be directed. In the above examples, the interworking function 50C of provider edge 34C would be identified in the destination IWF identifier 60. The destination MAC address 62 may be a separate field in the packet for storing the new MAC address to which communication traffic should be directed. Providing a separate field for the new MAC address may make it easier for the interworking function that receives the packet to identify the new MAC address to which the communication traffic should be redirected. Alternatively, the new MAC address may be obtained from the source MAC address of the packet network header 54.

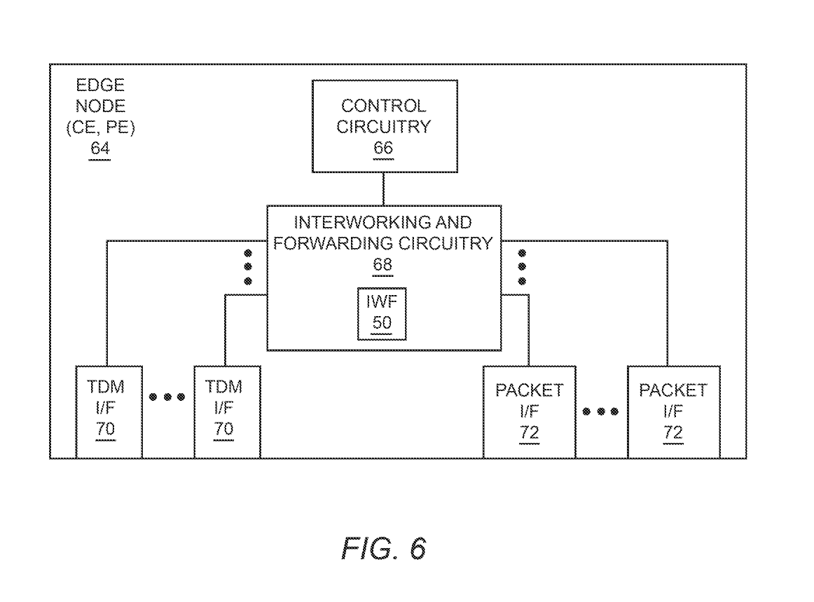

With reference to FIG. 6, an exemplary architecture of an edge node 64, such as the customer edge 36 or provider edges 34A, 34B, and 34C, is illustrated. The edge node 64 may include control circuitry 66, interworking and forwarding circuitry 68, one or more TDM interfaces 70, and packet interfaces 72. The interworking and forwarding circuitry 68 resides between the TDM interfaces 70 and the packet interfaces 72. Each TDM interface 70 is configured to interface with one or more TDM circuits, such as T1, T3, E1, or E3 circuits or STM-N (N=1, 4, 16, 64, etc.), which may connect to the base transceiver station 40, base station controller 44, or the like. Using the interworking function 50 provided by the interworking and forwarding circuitry 68, the TDM based communication traffic arriving at a TDM interface 70 from a TDM source is broken into segments, packetized, and forwarded toward another edge node 64 via the packet interface 72 and packet network 32 as packet based communication traffic. In the reverse direction, packet based communication traffic arriving at the packet interface 72 from a packet source are processed to extract the segmented communication traffic in the payloads of the packets and provide TDM based communication traffic that is transmitted by one of the TDM interfaces 70 to a TDM network.

Those skilled in the art will recognize improvements and modifications to the preferred embodiments of the present disclosure. All such improvements and modifications are considered within the scope of the concepts disclosed herein and the claims that follow.

### ELEMENT LISTING

10 Communication Network
12 Packet Network (PN)
14 Provider Edges (PE)
16 Customer Edges (CE)
18 Access Network (AN)
20 Base Transceiver Station (BTS)
22 User Elements (UE)
24 Base Station Controller (BSC)
26 Attachment Circuits
28 Interworking Function (IWF)
30 Communication Network
32 Packet Network (PN)
34 Provider Edges (PE)
36 Customer Edges (CE)
38 Access Network (AN)
40 Base Transceiver Station (BTS)
42 User Elements (UE)
44 Base Station Controller (BSC)
46 Attachment Circuits
48 Core Network
50 Interworking Function (IWF)
52 Error Message
54 Packet Network Header
56 Edge Control Header
58 Service Identifier Header
60 Destination IWF Identifier
62 Destination MAC Address
64 Edge Node
66 Control Circuitry
68 Forwarding Circuitry
70 TDM Interfaces
72 Packet Interfaces
74 Interworking Circuitry

### ACRONYM LISTING

BSC base station controller
BTS base transceiver station
CDMA code division multiple access
CE customer edge
E-NET Ethernet-based network
G First Generation
2G Second Generation
3G Third Generation
ICCP Inter-Chassis Communication Protocol
IETF Internet Engineering Task Force
IP Internet Protocol
ITU International Telecommunication Unit
LSP Label Switched Path
MAC media access control
MEN Metropolitan Ethernet Networks
MPLS Multi-Protocol Label Switched
OFDMA orthogonal frequency division multiple access
PE provider edge
PN packet network
PSTN Public Switched Telephone Network
PW Pseudowire
RNC radio network controller
SDH synchronous digital hierarchy
SONET synchronous optical networking
TDM Time-division multiplexing
TDMA time division multiple access
UE user element
VLAN virtual local area network

What is claimed is:

1. A first edge node having a first media access control (MAC) address and comprising:
at least one packet interface;
at least one non-packet interface; and
circuitry associated with the at least one packet interface and the at least one non-packet interface and adapted to:
detect a failure associated with a second edge node having a second media access control address: and
upon detecting the failure, send a switch request message to a third edge node to indicate that the third edge node should switch from sending traffic for a first session toward the second edge node using the second media access control address to sending the traffic for the first session to the first edge node using the first media access control address.

2. The first edge node of claim 1 wherein after the third edge node begins sending the traffic for the first session to the first edge node using the first media access control address, the circuitry is adapted to receive the traffic in the form of packets via the at least one packet interface, adapt the packets to a non-packet traffic that is compatible with a non-packet network coupled to the at least one non-packet interface, and forward the non-packet traffic via the at least one non-packet interface over the non-packet network.

3. The first edge node of claim 2 wherein the at least one non-packet interface is a time division multiplexed interface and the non-packet network is a time division multiplexed network.

4. The first edge node of claim 1 wherein the failure associated with the second edge node is a failure of the second edge node.

5. The first edge node of claim 4 wherein the circuitry is further adapted to monitor operational messages that are periodically sent by the second edge node to indicate that the second edge node is operational and detect the failure when the second edge node stops sending the operational messages.

6. The first edge node of claim 4 wherein the circuitry is further adapted to periodically send status request messages to the second edge node, monitor operational messages that are sent in response to the status request messages by the second edge node to indicate that the second edge node is operational, and detect the failure when the second edge node stops sending the operational messages.

7. The first edge node of claim 1 wherein the failure associated with the second edge node is a failure along a communication path for the first session downstream of the second edge node.

8. The first edge node of claim 7 wherein the failure associated with the second edge node is a failure in an attachment circuit that is coupled to the second edge node and used to support the communication path downstream of the second edge node.

9. The first edge node of claim 7 wherein the circuitry is further adapted to receive an operational message that is sent by the second edge node to alert the first edge node of the failure and detect the failure upon receiving the operational message.

10. The first edge node of claim 1 wherein the first edge node is a primary edge node wherein the at least one packet interface is coupled to a packet network and the at least one non-packet interface is coupled to a time division multiplexed attachment circuit.

11. The first edge node of claim 10 wherein the time division multiplexed attachment circuit is coupled between the first edge node and at least one of a base station controller and a radio network controller.

12. The first edge node of claim 1 wherein the first edge node is a customer edge node wherein the at least one packet interface is coupled to a packet network and the at least one non-packet interface is coupled to a base transceiver station in a wireless access network.

13. A system comprising:
a primary edge node that is coupled between a packet network and a non-packet network and adapted to interwork traffic for a first session via a first communication path extending through the primary edge node; and
a secondary edge node that is coupled between the packet network and the non-packet network and adapted to:
detect a failure associated with the primary edge node, which is associated with a primary media access control address that is used to direct the traffic from an originating edge node to the primary edge node; and
upon detecting the failure, send a switch request message including a secondary media access control address that is associated with the secondary edge node to the originating edge node to indicate that the originating edge node should switch from sending the traffic for the first session toward the primary edge node using the primary media access control address to sending traffic for the first session to the secondary edge node using the secondary media access control address.

14. The system of claim 13 wherein the non-packet network is a time division multiplexed network, the primary edge node is coupled to the time division multiplexed network via a first attachment circuit and at least one of a base station controller and a radio network controller, and the secondary edge node is coupled to the time division multiplexed network via a second attachment circuit and the at least one of a base station controller and a radio network controller.

15. The system of claim 14 wherein the originating edge node is coupled between the packet network and a wireless access network that supports wireless communications with a user element.

16. The system of claim 13 wherein after the failure is detected:
the originating edge node sends the traffic for the first session toward the secondary edge node using the secondary media access control address; and
the secondary edge node is adapted to receive and interwork the traffic for the first session via a second communication path extending through the primary edge node.

17. The system of claim 13 wherein the failure associated with the primary edge node is a failure of the primary edge node.

18. The system of claim 17 wherein the secondary edge node is further adapted to monitor operational messages that are periodically sent by the primary edge node to indicate that the primary edge node is operational and detect the failure when the primary edge node stops sending the operational messages.

19. The system of claim 13 wherein the secondary edge node is further adapted to periodically send status request messages to the primary edge node, monitor operational messages that are sent in response to the status request messages by the primary edge node to indicate that the primary edge node is operational, and detect the failure when the primary edge node stops sending the operational messages.

20. The system of claim 13 wherein the failure associated with the primary edge node is a failure along the first communication path downstream of the primary edge node, the primary edge node is adapted to detect the failure and send a message indicative of the failure to the secondary edge node, and the message indicative of the failure is used by the secondary edge node to detect the failure.

21. The system of claim 20 wherein the failure associated with the second edge node is a failure in an attachment circuit that is coupled to the primary edge node and used to support the first session.

22. The system of claim 20 wherein the secondary edge node is further adapted to receive an operational message that is sent by the primary edge node to alert the secondary edge node of the failure and detect the failure upon receiving the operational message.

23. The system of claim 13 wherein the primary edge node and the secondary edge node are provider edge nodes coupled to a core network and the originating edge node is a customer edge node coupled to a wireless access network.

24. An edge node comprising:
at least one packet interface;
at least one non-packet interface; and
circuitry associated with the at least one packet interface and the at least one non-packet interface and adapted to:
interwork and forward communication traffic received from the at least one non-packet interface for a first communication session toward a primary edge node via the at least one packet interface using a primary media access control address that is associated with the primary edge node;
receive a switch request message from a secondary edge node wherein the switch request message includes a second media access control address that is associated with the secondary edge node; and
in response to receiving the switch request message, interwork and forward the communication traffic received from the at least one non-packet interface for the first communication session toward the secondary edge node via the at least one packet interface using the secondary media access control address.

25. The edge node of claim 24 wherein the at least one non-packet interface is a time division multiplexed interface.

26. A method for operating a first edge node having a first media access control address comprising:
detecting a failure associated with a second edge node having a second media access control address; and
upon detecting the failure, sending a switch request message to a third edge node to indicate that the third edge node should switch from sending traffic for a first session toward the second edge node using the second media access control address to sending the traffic for the first session to the first edge node using the first media access control address.
